(19) United States
(12) Patent Application Publication
(10) Pub. No.: US 2010/0162027 A1
(43) Pub. Date: Jun. 24, 2010

(54) HEALTH CAPABILITY DETERMINATION SYSTEM AND METHOD

(75) Inventors: Robert C. McCroskey, Burnsville, MN (US); Harold Carl Voges, Shoreview, MN (US); Darryl Busch, Eden Prairie, MN (US); George Daniel Hadden, Plymouth, MN (US)

Correspondence Address: HONEYWELL/IFL;Patent Services, 101 Columbia Road, P.O.Box 2245, Morristown, NJ, 07962-2245, US

(73) Assignee: HONEYWELL INTERNATIONAL INC., Morristown, NJ (US)

(21) Appl. No.: 12/341,648

(22) Filed: Dec. 22, 2008

(51) Int. Cl. G06F 11/00

(52) U.S. Cl. 714/1; 714/E11.02

(57) ABSTRACT

A system and method are provided for the determining of the potential effect(s) that a degraded system, subsystem, or component may have on the overall capabilities of a vehicle or other system, and any mitigating actions that may need to be taken. Mission-related capabilities of the system are decomposed into a plurality of lower-level capabilities that have an impact on the mission-related capabilities. One or more faults that have an impact on at least one of the lower-level capabilities are mapped to appropriate lower-level capabilities. The lower-level capabilities to which the one or more vehicle faults is mapped are computed, and values of the mission-related capabilities are computed from each of the lower-level capabilities.

### STATEMENT REGARDING FEDERALLY SPONSORED RESEARCH OR DEVELOPMENT

This invention was made with Government support under F33615-00-D-3053 awarded by the Air Force Research Laboratory (AFRL). The Government has certain rights in this invention.

### TECHNICAL FIELD

The present invention generally relates to health management and, more particularly, to a system and method of determining the capabilities of a system, such as a vehicle and/or one or more systems within the vehicle, using various health-related data.

### BACKGROUND

Various systems, such as various types of vehicles and the systems and subsystems that comprise the vehicles, may be subject to potentially severe environmental conditions, shock, vibration, and normal component wear. These conditions, as well as others, may have deleterious effects on vehicle operability. These deleterious effects, if experienced during operation, could leave little time for corrective actions. Hence, most notably in the context of vehicles, health monitoring/management systems are increasingly being used. Vehicle health monitoring/management systems monitor various health-related characteristics of the vehicle. Such operational health characteristics may, in some instances, be further decomposed to the health characteristics of major operational systems and subsystems of the vehicle.

In addition to monitoring vehicle health status, it would be desirable to determine the potential effect that a potentially degraded system, subsystem, or component may have on the overall capabilities of the vehicle, and supply information of these potential effects so that a system may, if needed, reconfigure itself to accommodate such a degraded system, subsystem, or component. For example, if a fault degrades vehicle engine thrust to a point where the vehicle will be unable to successfully complete its mission, mitigating actions (such as abort or re-plan) may be needed to minimize the impact of the fault. Heretofore, such capabilities have not been implemented with adequate precision and/or without undue complexity.

Hence, there is a need for a system and method that determines, with adequate precision and without undue complexity, the potential effect(s) that a degraded system, subsystem, or component may have on the overall capabilities of a vehicle (or other system), and supply information of the potential effect(s) so that mitigating actions may be taken. The present invention addresses at least this need.

### BRIEF SUMMARY

In one embodiment, and by way of example only, a method of determining a capability of a system includes representing a capability of the system as at least a lowest-level capability that is quantifiably impacted by one or more system faults, when present, and by no other capabilities of the system. The quantifiable impact of the one or more faults on the lowest-level capability is represented as a function of the one or more system faults on the lowest-level capability. A value of the capability of the system is computed from at least the one or more system faults that are present.

In another exemplary embodiment, method of determining a capability of a system includes representing a capability of the system as at least a lowest-level capability that is quantifiably impacted by one or more system parameters and by no other capabilities of the system. The quantifiable impact of the one or more system parameters on the lowest-level capability is represented as a function of the one or more system parameters on the lowest-level capability. A value of the capability of the system is computed from at least the one or more system parameters that are present.

In another exemplary embodiment, a method of determining capabilities of a system includes representing capabilities of the system as a directed acyclic graph that includes one or more higher-level capabilities and a constant capability. Each higher-level capability is quantifiably impacted by the constant capability or one or more other higher-level capability. A value of each higher-level capability is computed from the constant capability or the one or more other higher-level capabilities.

In yet a further exemplary embodiment, a vehicle health capabilities system includes a plurality of sensors and system health reasoner means. Each of the plurality of sensors is operable to sense a vehicle parameter and supply sensor data representative thereof. The system health capability reasoner means has capability data stored therein. The capability data are representative of a system capability that is represented as at least a lowest-level capability. The lowest-level capability is quantifiably impacted by one or more system faults and by no other capabilities of the system, and the quantifiable impact of the one or more faults on the lowest-level capability is represented as a function of the one or more system faults on the lowest-level capability. The system health capability reasoner means receives the sensor data, determines whether one or more of the system faults is present, determines the quantifiable impact of each fault that is present on the lowest-level capability, and computes a value of the capability of the system from at least the lowest-level capability.

Other desirable features and characteristics of the inventive health capability determination system and method will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and

FIG. 1 depicts a functional block diagram of a vehicle health capabilities system according to one exemplary embodiment of the present invention;

FIG. 2 depicts a representation of hierarchical data that may be used by the vehicle health capabilities system of FIG. 1;

FIG. 3 depicts one example of the hierarchical data of FIG. 2 for a vehicle mission capability of total vehicle thrust;

FIG. 4 depicts an exemplary representation of mission requirement value data that may be used by the vehicle health capabilities system of FIG. 1;

FIG. 5 depicts an exemplary alternative representation of how a mission requirement may be represented; and

FIG. 6 depicts a process diagram of an exemplary method that may be implemented by the system of FIG. 1, using the data depicted in FIGS. 2-4.

### DETAILED DESCRIPTION

The following detailed description is merely exemplary in nature and is not intended to limit the invention or the application and uses of the invention. Furthermore, there is no intention to be bound by any theory presented in the preceding background or the following detailed description. In this regard, although this detailed description focuses mainly on use of the invention in vehicles, it will be appreciated that its use is not limited to such an end-use environment, but may be implemented in numerous and varied end-use environments, and with numerous and varied systems in numerous and varied end-use environments.

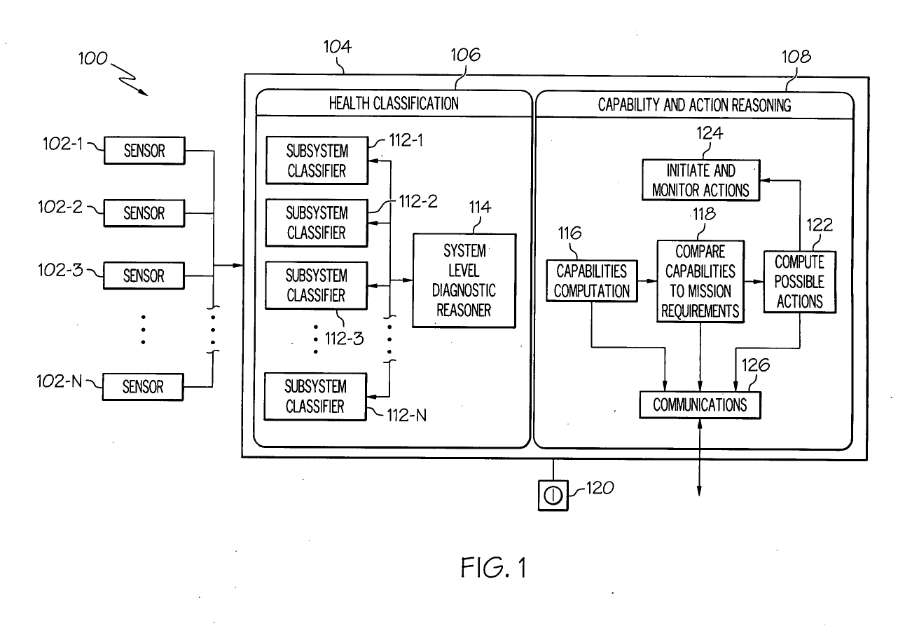

Referring to FIG. 1, a functional block diagram of an exemplary embodiment of a vehicle health capabilities system 100 is depicted. The depicted system 100 includes a plurality of sensors 102 (e.g., 102-1, 102-2, 102-3 . . . , 102-N) and a processing subsystem 104. Before proceeding, it is noted that the sensors 102 and processing subsystem 104 are, at least in the depicted embodiment, installed in a vehicle 150. The particular vehicle 150 may vary. For example, the vehicle 150 may be an aircraft, a satellite, a rocket, a missile, an unmanned autonomous vehicle (UAV), an automobile, a watercraft, a submarine, or various other vehicle types. It will additionally be appreciated, as was already noted, that the system 100 is not limited to vehicular environments.

Returning again to the description, the sensors 102 are each operable to sense a parameter and supply sensor data representative thereof. It will be appreciated that the number and type of sensors 102 may vary depending, for example, on the particular type of vehicle in which the system 100 is installed. Moreover, a plurality of the sensors 102 may be used to sense parameters in the same vehicle subsystem. For example, a plurality of the sensors 102 may be used to sense a plurality of parameters in one of a plurality of non-illustrated engines. No matter the particular number and type of sensors 102 used and the number and type of parameters that are sensed, each sensor 102 supplies sensor data representative of the sensed parameter to the processing subsystem 104.

The processing subsystem 104, which may also be referred to herein as a system health capability reasoner (SCHR), is coupled to receive the sensor data from each of the sensors 102. The processing subsystem 104 is configured to process the sensor data in a manner that allows of one or more capabilities of the vehicle 150 to be determined and, if needed, mitigating actions that should be implemented. More specifically, the processing subsystem 104 computes one or more capabilities of the vehicle 150 and, based on this computation, determines what mitigating actions, if any, should be implemented. To implement this functionality the processing subsystem 104 implements a plurality of modules. These modules, at least in the depicted embodiment, include a health classification module 106 and a capability and action reasoning module 108, each of which will be described in more detail further below.

Before describing the health classification module 106 and the capability and action reasoning module 108, it is noted that the processing subsystem 104 may be implemented, as needed or desired, using hardware, software, firmware, or various combinations thereof. In this regard, such hardware may include, for example, one or more general-purpose or application-specific programmable processors, suitable memory (separate from or integral to the processor(s)), and/or suitable input/output (I/O) devices. Moreover, the health classification module 106 and the capability and action reasoning module 108 will each be described in the context of implementing a plurality of functional modules or blocks. Similarly, each of these functional modules or blocks may, as needed or desired, be implemented using hardware, software, firmware, or various combinations thereof. Furthermore, the health classification module 106 and the capability and action reasoning module 108 may each implement functional modules or blocks in addition to those depicted in FIG. 1. Descriptions of these additional functional modules or blocks are not needed to fully describe or enable the claimed invention, and are therefore not provided.

Turning now to a description of the health classification module 106, it is seen that this module 106 implements at least a plurality of subsystem classifiers 112 (e.g., 112-1, 112-2, 112-3 . . . , 112-N) and a system level diagnostic reasoner 114. The subsystem classifiers 112 are each associated with a particular vehicle subsystem, and each receives sensor data supplied from one or more of the sensors 102. More specifically, each subsystem classifier 112 receives sensor data from the one or more sensors 102 that sense parameters associated with the same subsystem with which the subsystem classifier is associated. For example, if the first subsystem classifier 112-1 is associated with one or more engines, then it will receive sensor data from the one or more sensors 102 that sense engine-related parameters, if the second subsystem classifier 112-2 is associated with an avionics systems, then it will receive sensor data from the one or more sensors 102 that sense avionics system-related parameters, and so on. The subsystem classifiers 112, based on the sensor data each receives, and implementing any one of numerous known algorithms, determine and classify (e.g., compute) vehicle faults at the subsystem level.

The system level diagnostic reasoner 114 communicates with each of the subsystem classifiers 112. The system level diagnostic reasoner 114 determines and classifies vehicle faults at the system level. That is, the system level diagnostic reasoner 114 uses sensor data and/or classifier-supplied data associated with all of the subsystems and, implementing any one of numerous known algorithms, determines and classifies (e.g., computes) vehicle faults at the system level.

The computed vehicle subsystem faults and the computed vehicle system faults together constitute what is referred to herein as the computed system health data. The computed system health data not only indicate the presence of particular faults, but a computed value associated with a particular fault. For example, in the context of a vehicle, the computed health system data supplied by the health classification module 106 will not only indicate that a low tire pressure fault is present, but will additionally include the actual tire pressure value. It will be appreciated that the computed system health data may be used for various diagnostic and prognostic purposes, as is generally known in the art. In the SHCR 104, however, the computed system health data are also (or instead) used in the capability and action reasoning module 108, an embodiment of which will now be described.

The capability and action reasoning module 108 includes at least a capabilities computation module 116, a capabilities comparison module 118, and an action computation module 122. The capabilities computation module 116 receives, or at least selectively retrieves, the computed system health data from the health classification module 106. The capabilities computation module 116, based on these data, computes one or more capabilities of each of the various vehicle subsystems, at least some of which may impact overall vehicle mission or a particular aspect of the overall vehicle mission. The methodology that the capabilities computation module 116 implements to compute these capabilities will be described in more detail further below. The capabilities computed by the capabilities computation module 116 are supplied to, or selectively retrieved by, the capabilities comparison module 118.

The capabilities comparison module 118, using the computed capabilities supplied to or selectively retrieved from the capabilities computation module 116, compares the computed capabilities to one or more vehicle mission requirement values, preferably before, during, and after a particular mission. The capabilities comparison module 118, based on the comparison of the overall vehicle mission capability and the vehicle mission requirement value(s), determines if a corrective action should be initiated. If it is determined that a corrective action should be initiated, the action computation module 122 computes the particular mitigating action (or actions) that should be initiated. More specifically, the action computation module 122 computes the mitigating action(s) based on the computed capabilities and the vehicle mission requirement value(s). The capabilities comparison module 118 may also receive data representative of future vehicle mission requirements, and may compare the computed capabilities to the future vehicle mission requirements to determine which, if any, of the future vehicle mission capabilities may or may not be met.

As FIG. 1 also depicts, the capability and action reasoning module 108, at least in the illustrated embodiment, further includes an action initiation and monitor module 124 and a communications module 126. The action initiation and monitor module 124 receives, or at least selectively retrieves, the mitigating action(s) computed by the action computation module 122, and automatically implements and monitors the particular mitigating action(s). For example, if the computed mitigating action were to increase fuel flow to one or more vehicle engines, to thereby increase overall vehicle thrust to a desired thrust magnitude, the action initiation and monitor module 124 would ensure that this mitigating action is automatically initiated, and monitor the progress of the mitigating action.

The communications module 126, at least in the depicted embodiment, is in operable communication with the capabilities computation module 116, the capabilities comparison module 118, and the action computation module 122. The communications module 126 is configured to at least selectively transmit data representative of, for example, one or more of the computed capabilities, the determination of whether a corrective action should be initiated, and the computed mitigating action(s), to a remote location. In the context of this disclosure, the remote location may include one or more other systems on-board the vehicle 150, one or more systems disposed remotely from the vehicle 150, or combinations of both.

In addition to the above, the capability and action reasoning module 108 may also generate and supply appropriate commands to one or more display devices 120 (only one shown for clarity). The display device(s) 120, if included, provides visual feedback that is at least representative of one or more vehicle mission requirement values. The particular type of display device(s) 120 used and the particular display paradigm may vary. In one particular embodiment a color variation paradigm is used. For example, if a current vehicle mission requirement value is a vehicle speed of at least 500 km/hr, and the calculated vehicle speed capability is 1000 km/hr, then the display device 120 may be commanded to display a green color. If the calculated vehicle speed capability is below a first threshold value, such as 800 km/hr for example, then the display device 120 may be commanded to display a yellow color. If the calculated vehicle speed capability is below 500 km/hr (i.e., the current vehicle mission requirement), then the display device 120 may be commanded to display a red color. As with the variation in indicator paradigms, the particular colors and numbers of colors used may also vary. A description of various other display paradigms and various other types of information that may be displayed on the display device(s) 120 is provided further below.

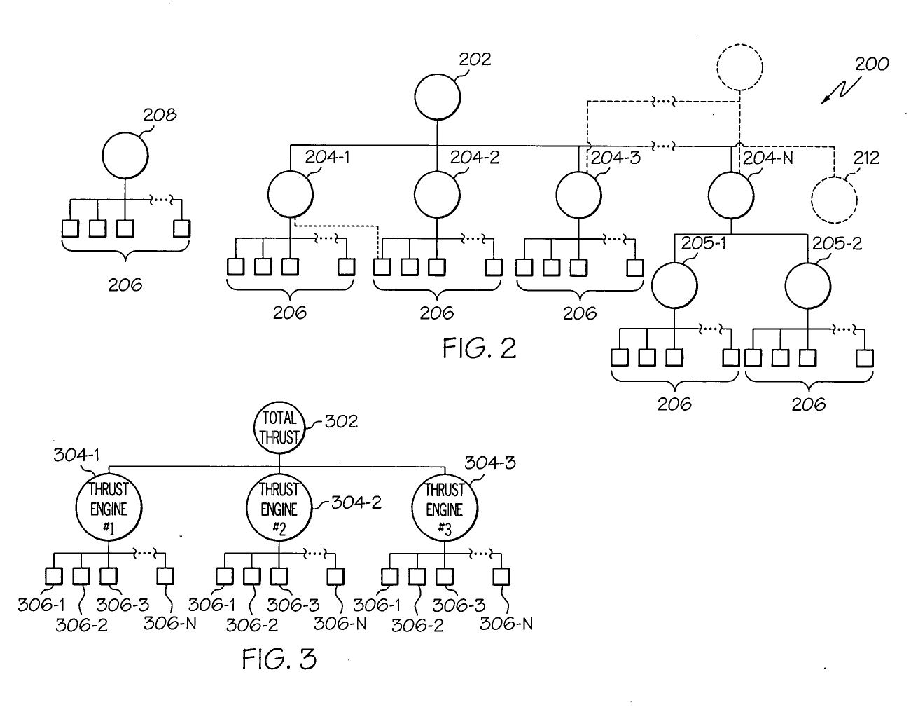

Referring now to FIG. 2, it was noted above that the capabilities computation module 116 computes, based on the system health data, the capability of each of the various vehicle subsystems that may impact either overall vehicle mission or a particular aspect of the overall vehicle mission. To do so, the capabilities computation module 116 uses what are referred to herein as capability data. These data are system capabilities that are represented as a directed acyclic graph 200. Within each directed acyclic graph 200 at least one of the capabilities may be a mission-related capability. Moreover, an the vehicle may have an overall capability, which may be represented as a directed acyclic graph that may include capabilities associated with one or more other directed acyclic graphs. A directed acyclic graph 200, such as the one depicted in FIG. 2, may include zero or more higher-level capabilities and one or more lowest-level capabilities.

As used herein, a higher-level capability is one that is quantifiably impacted by at least one other capability. A lowest-level capability is one that is not quantifiably impacted by any other capabilities. Rather, a lowest-level capability is one that is quantifiably impacted by a system fault (e.g., appropriate system health data) or system parameter (e.g., an operational parameter such as speed, fuel level, etc.). It will be appreciated that in some instances a lowest-level capability may not be impacted by a system fault or parameter. Such lowest-level capabilities are referred to herein as constant capabilities. It may thus be seen that in the directed acyclic graph 200 of FIG. 2, the higher-level capability 202 is a quantifiably impacted by N-number of other capabilities 204 (e.g., 204-1, 204-2, 204-3 . . . 204-N). Of these N-number of other capabilities 204, the Nth capability (204-N) is quantifiably impacted by two other capabilities 205 (205-1, 205-2). Thus, the Nth capability 204-N is a higher-level capability. The first three capabilities 204-1, 204-2, 204-3 that quantifiably impact higher-level capability 202, and the two capabilities 205-1, 205-2 that quantifiably impact the Nth capability 204-N, are quantifiably impacted by one or more system faults or system parameters 206. Indeed, it is seen that the quantifiable impact of the one or more system faults and/or parameters 206 on each of these capabilities 204-1, 204-2, 204-3, 205-1, 205-2 is represented as a function of the one or more system faults and/or parameters 206 on (e.g., is mapped to) each of these capabilities 204-1, 204-2, 204-3, 205-1, 205-2. Thus, these five capabilities 204-1, 204-2, 204-3, 205-1, 205-2 are lowest-level capabilities.

The directed acyclic graphs that comprise the capability data used in the capabilities computation module 116 may vary in structure from that depicted in FIG. 2. For example, one or more higher-level capabilities may quantifiably impact more than one other higher-level capability, and a system fault or system parameter 206 may quantifiably impact more than one lowest-level capability. This is depicted in phantom in FIG. 2, where the third and fourth lowest-level capabilities 204-3, 204-4 both quantifiably impact a second higher-level capability 203, and one of the system faults and or parameters 206 is commonly mapped to both the first and second lowest-level capabilities 204-1, 204-2. Moreover, and as FIG. 2 further depicts, in some instances a capability may be represented as only a single lowest-level capability 208.

Before proceeding further, it was noted above that a lowest-level capability may also, in some instances, be a constant capability. That is, a capability that is not impacted by a system fault or parameter. For completeness, a constant capability 212 is also depicted in phantom in FIG. 2. In the depicted embodiment, this constant capability 212 quantifiably impacts the higher-level capability 202.

A relatively simple, yet illustrative example of capability data 200 that may be used by the capabilities computation module 116 is depicted in FIG. 3. In this example, the directed acyclic graph includes a single higher-level capability 302, which is also a mission-related capability, of total vehicle thrust. The total vehicle thrust higher-level capability 302 is quantifiably impacted by other thrust capabilities, one each associated with each engine. In the depicted example, the vehicle is assumed to include three engines, and the total vehicle thrust capability 302 is the vector sum of each of the three individual engine thrust capabilities 304-1, 304-2, 304-3. Thus, the total thrust capability 302 is quantifiably impacted by these three capabilities 304-1, 304-2, 304-3. The individual engine thrust capabilities 304-1, 304-2, 304-3 are in turn impacted by their specific individual engine health and/or system parameters, and are thus lowest-level capabilities. The calculated engine health data (e.g., engine faults) and system parameters 306 associated with each engine are mapped to the individual engine thrust capabilities 304-1, 304-2, 304-3.

It will be appreciated that individual engine thrust capability 304-1, 304-2, 304-3 may be impacted by any one of numerous faults and/or parameters, or various combinations of these numerous faults and parameters. As such, FIG. 3 depicts that a plurality of engine faults and parameters (e.g., 306-1, 306-2, 306-3 . . . , 306-N) may be mapped to each individual engine thrust capability 304. To provide an illustrative example of one particular type of engine fault 306 and its individual and overall impact, it is known that blockage in a fuel line may result in reduced engine thrust. Hence, this particular engine fault 306 is quantifiably mapped to its associated engine capability 304. If, during operation, the health classification module 104 determines that a fuel line blockage fault 306 (having a magnitude of 20% blockage) exists for an engine (e.g., Engine 1), the capabilities computation module 116 will compute a concomitant reduction in the individual engine thrust capability for that engine 304-1, as well as a reduction in the total vehicle thrust capability 302.

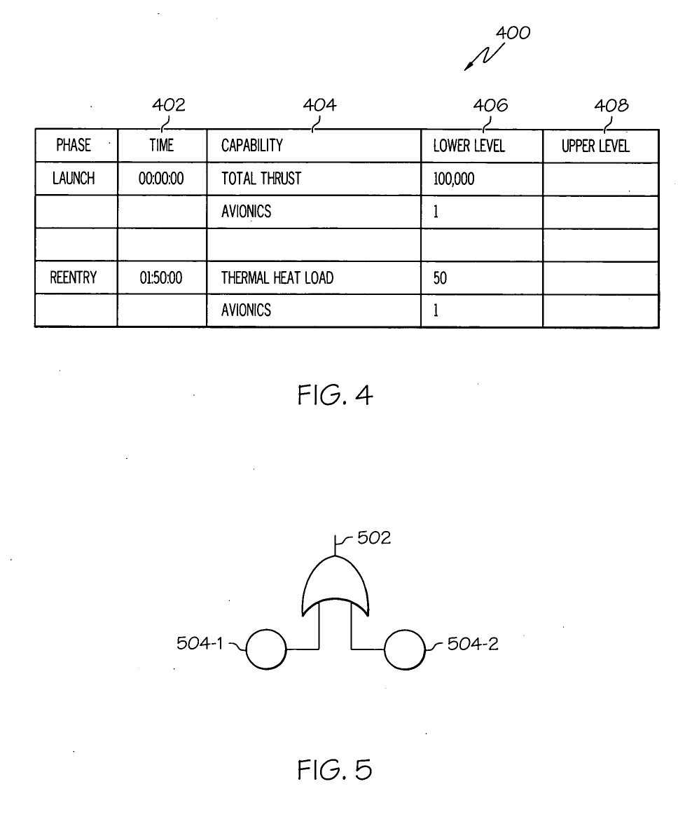

It was additionally noted above that the capabilities comparison module 118 compares the computed capabilities (e.g., the mission-related capabilities) to one or more vehicle mission requirement values and, based on this comparison, determines if a corrective action should be initiated. The manner in which this comparison is implemented may vary, but in one particular embodiment the computed capabilities are compared to appropriate vehicle mission requirement value data. These data may, at least in one embodiment, be stored in a table format. An example of one such table format is depicted in FIG. 4, and will now be described.

The exemplary table 400 depicts vehicle mission requirement value data associated with two different operational phases of a vehicle. In this case, the vehicle is a UAV-type vehicle that is controlled to implement at least a Launch Phase and a Reentry Phase. The depicted table 400 includes time data 402, mission-related capability category data 404, lower level data 406, and upper level data 408. It will be appreciated that these particular data are merely exemplary of one particular embodiment and could be varied, as needed or desired. Similarly, the data values depicted in FIG. 4 and described herein are merely exemplary of one particular embodiment and may also be varied, as need or desired.

The time data 402 indicates at what point in time, during vehicle operation, each operational phase is scheduled to commence. In the depicted embodiment the Launch Phase, as may be appreciated, commences at time zero (e.g., 00:00:00) and the Reentry Phase begins 1 hour and 50 minutes (e.g., 01:50:00) after commencement of the Launch Phase. The capability category data 404 include entries for each of the particular high-level/mission-related capabilities associated with each phase. In the depicted embodiment, two high-level/mission-related capabilities are associated with each phase. For the Launch Phase the two high-level/mission-related capabilities are Total Thrust and Avionics, and for the Reentry Phase the two high-level/mission-related capabilities are Thermal Heat Load and Avionics.

The lower level data 406 and upper level data 408 represent the minimum and maximum values, respectively, for each high-level/mission-related capability during each launch phase. For this particular example, there are only lower level data 406. As may be seen, the minimum total thrust value during the Launch Phase of the vehicle is 100,000 lbs, and the minimum number of operating avionics channels is one (1). During the Reentry Phase, the minimum Thermal Heat Load is 50 BTU/ft², and the minimum number of operating avionics channels is again one (1).

In addition to or instead of a mission requirement table 400, some mission requirements may be represented as a logical combination of a plurality of capabilities. In such embodiments, the determination of whether the appropriate mission requirement is met is based on the logical outcome of the logical combination. An example of such an embodiment is depicted in FIG. 5. In this embodiment, the mission requirement 502 is represented as the logical-OR of two capabilities 504-1, 504-2. That is, if either capability 504-1, 504-2 is a logical “true” then the mission requirement is met. It will be appreciated that the logical combination that may be implemented need not be a logical-OR, but may be any one of numerous logical combinations, including logical-AND, -NAND, NOR, XOR, etc., just to name a few.

Though not depicted in FIG. 4 or 5, in some embodiments the vehicle mission requirement value data may additionally include mitigation action data. These data would represent the mitigating action (or actions) that should be implemented, either automatically or manually, if the high-level/mission-related capability is below its minimum value or above its maximum value. It will be appreciated that in such instance, the action computation module 122 described above and depicted in FIG. 1 may be eliminated.

Before proceeding further it is noted that the capability data and the vehicle mission requirement value data may be stored in memory that forms part of the processing subsystem 104 or in memory external to the processing subsystem 104. Additionally, the capability data and vehicle mission requirement value data may be stored in shared memory (within or separate from the processing subsystem 104) or may be stored in separate memory.

Moreover, it was also previously noted that the processing subsystem 104 may command the display device(s) 120 depicted in FIG. 1 to display various types of information using various display paradigms. In some embodiments, the processing subsystem 104 may selectively command the display device(s) 120 to display the directed acyclic graphs 200 associated with the vehicle/system. The processing subsystem 104 may also allow a user to selectively expand and collapse one or more of the displayed lattices 200, if needed or desired. The processing subsystem 104 may also selectively command the display device(s) 120 to numerically display one or more capabilities. The processing subsystem 104 may also selectively command the display device(s) 120 to display the status of one or more actual capabilities to one or more capability requirements using various highlighting techniques (e.g., color, texture, etc.), and/or bar or dial displays to indicate the status of one or more actual capabilities as compared to one or more dynamic threshold requirements.

The processing subsystem 104 may also selectively command the display device(s) 120 to display the above-described mission requirement table(s) and, either automatically or in response to input from a user, selectively expand and collapse one or more of the displayed mission requirement tables based, for example on a particular mission phase. In some embodiments, the mission phase may be highlighted. When one or more mission requirements tables are displayed, the processing subsystem 104 may selectively command the display device(s) 120 to highlight any rows in the displayed mission requirement tables based in whether the particular capability is met or unmet.

In addition to the above, the processing subsystem 104 may selectively command the display device(s) 120 to display a plot of various vehicle/system requirements versus time (or mission phase) overlaid with actual vehicle/system capabilities, and/or display various vehicle/system requirements and capabilities using synoptic diagrams, and/or display at least portions of one or more directed acyclic graphs 200.

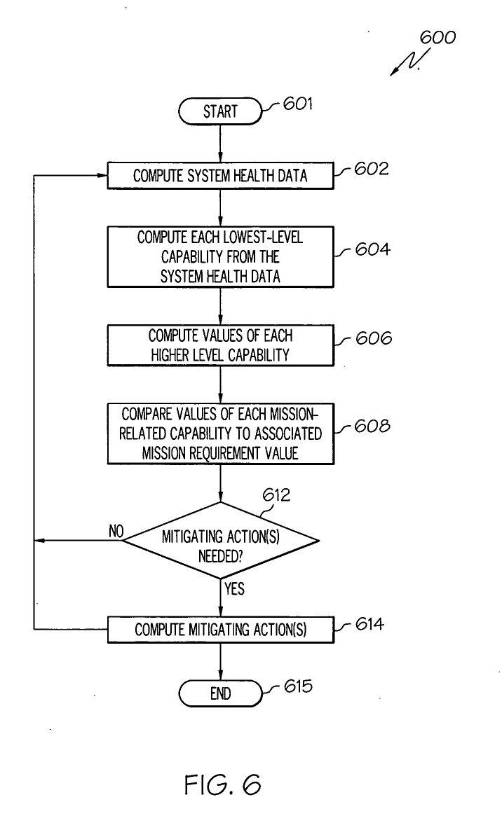

Having described the general structure and function of the vehicle health capabilities system 100, an exemplary process implemented by the system 100 for determining one or more mission-related capabilities of a vehicle is depicted in FIG. 6 and will now is described. In doing so, it is noted that the parenthetical references in the following description refer to like numbered blocks in the process flowchart of FIG. 6.

Upon initiating the process 600, the processing subsystem 104, using the sensor data from the sensors 102, computes the system health data (602). Each of the lowest-level capabilities are then computed from the system health data (604) and, when appropriate, each of the higher-level capabilities are computed from the lowest-level capabilities (606). The values of each of the mission-related capabilities (whether higher-level or lowest-level capabilities) that were just computed are then compared to appropriate mission requirement values or supplied to appropriate combination logic (608). Based on this comparison (or logic combination), a determination is made as to whether one or more mitigating actions are needed (612). If so, then the mitigating actions are computed and implemented (614) and the process repeats. If no mitigating actions are needed, then the process repeats.

The system and method described herein provide for the determination of the potential effect(s) that a degraded system, subsystem, or component may have on the overall capabilities of a vehicle (or other system), and any mitigating actions that may need to be taken.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method of determining a capability of a system, comprising the steps of:
representing a capability of the system as at least a lowest-level capability, the lowest-level capability quantifiably impacted by one or more system faults, when present, and by no other capabilities of the system;
representing the quantifiable impact of the one or more faults on the lowest-level capability as a function of the one or more system faults on the lowest-level capability; and
computing a value of the capability of the system from at least the one or more system faults that are present.

2. The method of claim 1, wherein the system includes a plurality of capabilities, and wherein the method further comprises:
representing the capabilities of the system as a directed acyclic graph that includes one or more higher-level capabilities and the lowest-level capability, each higher-level capability quantifiably impacted by the lowest-level capability or another higher-level capability; and
computing a value of the higher-level capability from the lowest-level capability or the other higher-level capability.

3. The method of claim 2, wherein:
the other higher-level capability is quantifiably impacted by another lowest-level capability; and
the method further comprises:
computing a value of the other higher-level capability from the other lowest-level capability, and
computing a value of the higher-level capability from the other higher-level capability.

4. The method of claim 2, wherein one or more of the capabilities is a mission-related capability.

5. The method of claim 1, further comprising:
representing a plurality of system capabilities as directed acyclic graphs that each include one or more higher-level capabilities and one or more lowest-level capabilities, each higher-level capability in each directed acyclic graph quantifiably impacted by a lowest-level capability or another higher-level capability; and
computing a value of each higher-level capability from one or more lowest-level capabilities or another higher-level capability.

6. The method of claim 5, wherein:
each of the other higher-level capabilities are quantifiably impacted by one or more lowest-level capabilities; and
the method further comprises:
computing a value of each of the other higher-level capabilities from the one or more lowest-level capabilities.

7. The method of claim 6, wherein at least one of the higher-level capabilities or lowest-level capabilities is a mission-related capability.

8. The method of claim 7, further comprising:
comparing a computed value of each mission-related capability to current and future mission requirement values.

9. The method of claim 8, further comprising:
comparing the computed value of each mission-related capability to current and future mission requirement values before, during, and after a system mission.

10. The method of claim 8, wherein:
the current and future mission requirement values are stored in a mission requirement table; and
the mission requirement table includes one or more of required mission capabilities, times, and phases.

11. The method of claim 10, further comprising:
selectively displaying at least a portion of the mission requirement table.

12. The method of claim 11, further comprising:
selectively varying a display characteristic of one or more portions of the mission requirement table, based at least in part on the comparison of the computed value of the mission-related capability to the predetermined mission requirement value.

13. The method of claim 8, further comprising:
determining, from the comparison, if a mitigating action should be initiated; and
initiating the mitigating action if it is determined that the mitigating action should be initiated.

14. The method of claim 8, further comprising:
displaying the comparison of the computed value of the mission-related capability to the current and future mission requirement values.

15. The method of claim 7, further comprising:
representing a mission requirement as a logical combination of a plurality of mission-related capabilities, the logical combination having a logical outcome; and
determining if the mission requirement is met based on the logical outcome of the logic combination.

16. The method of claim 1, further comprising:
sensing a plurality of parameters in the system;
determining, from one or more of the sensed parameters, if one or more of the system faults is present.

17. The method of claim 1, further comprising:
displaying an indicator representative of the computed value of the capability.

18. The method of claim 2, further comprising:
selectively displaying at least a portion of the directed acyclic graph.

19. The method of claim 1, further comprising:
transmitting the computed value of the capability to a remote location.

20. The method of claim 1, wherein the system has an overall capability, and wherein the method further comprises:
representing the overall capability as a directed acyclic graph that includes at least a higher-level capability and the lowest-level capability, the higher-level capability quantifiably impacted by at least the lowest-level capability; and
computing a value of the higher-level capability from the lowest-level capability.

21. The method of claim 1, wherein:
the lowest-level capability is quantifiably impacted by one or more system parameters; and
the method further comprises representing the quantifiable impact of the one or more system parameters on the lowest-level capability as a function of the one or more system parameters.

22. A method of determining a capability of a system, comprising the steps of:
representing a capability of the system as at least a lowest-level capability, the lowest-level capability quantifiably impacted by one or more system parameters and by no other capabilities of the system;
representing the quantifiable impact of the one or more system parameters on the lowest-level capability as a function of the one or more system parameters on the lowest-level capability; and
computing a value of the capability of the system from at least the one or more system parameters that are present.

23. A method of determining capabilities of a system, comprising the steps of:
representing capabilities of the system as a directed acyclic graph that includes one or more higher-level capabilities and a constant capability, each higher-level capability quantifiably impacted by the constant capability or one or more other higher-level capability; and
computing a value of each higher-level capability from the constant capability or the one or more other higher-level capabilities.

24. A system health capabilities system, comprising:
a plurality of sensors, each sensor operable to sense a system parameter and supply sensor data representative thereof;
system health capability reasoner means having capability data stored therein, the capability data representative of a system capability that is represented as at least a lowest-level capability, the lowest-level capability quantifiably impacted by one or more system faults and by no other capabilities of the system, the quantifiable impact of the one or more faults on the lowest-level capability represented as a function of the one or more system faults on the lowest-level capability, the system health capability reasoner means for:
receiving the sensor data,
determining whether one or more of the system faults is present,
determining the quantifiable impact of each fault that is present on the lowest-level capability, and
computing a value of the capability of the system from at least the lowest-level capability.
